(19) United States
(12) Patent Application Publication
(10) Pub. No.: US 2026/0156052 A1
(43) Pub. Date: Jun. 4, 2026

(54) NODE ACTION SEQUENCE REORDERING FOR RESOURCE REALLOCATION

(71) Applicant: Stripe Inc., South San Francisco, CA (US)

(72) Inventors: Ripul Jain, South San Francisco, CA (US); Andrew Straussman, South San Francisco, CA (US); David Ebrahim Yves Hatanian, South San Francisco, CA (US); Devesh Chourasiya, South San Francisco, CA (US); Scott Triglia, South San Francisco, CA (US); Maria Luísa Cantadori, South San Francisco, CA (US)

(73) Assignee: Stripe Inc., South San Francisco, CA (US)

(21) Appl. No.: 18/969,178

(22) Filed: Dec. 4, 2024

(51) Int. Cl. H04L 41/5019; H04L 41/0816; H04L 41/16

(52) U.S. Cl. CPC H04L 41/5019; H04L 41/0816; H04L 41/16

(57) ABSTRACT

In some embodiments, a server system may re-allocate a resource to a node from a shared pool of available resources and reschedule the added allocation. Some embodiments may use such operations to avoid triggering application-terminating thresholds and increase the efficiency and consistency of a networked computing system. In response to obtaining a result indicating whether an action will cause a resource allocation level of a node to fail to satisfy a threshold, some embodiments may delay the action by a buffer duration and allocate a set of resources from a resource pool to the node. As such, in some embodiments, the set of resources may be available to the node before an end of the buffer duration. Thus, at the end of the buffer duration or after the buffer duration, some embodiments may execute the action without triggering a failure condition related to the node.

### SUMMARY

Methods and systems described herein are directed to preventing performance failure related to a node (or other failure conditions) by, for example, reordering a sequence of network operations or other actions controlling resource allocations to resource-sharing nodes, delaying such actions (e.g., via a buffer duration), etc.

In the context of computer networks, the ability of a server to dynamically allocate resources to individual nodes is important in various types of distributed systems. These operations can increase the ability of nodes to execute applications and perform functions important to various types of distributed computing operations. In many cases, a server may allocate a resource to a node from a shared pool of available resources. The server may manage resource allocations to satisfy criteria related to the resource pool, applications, or nodes. Such servers may often face difficulties when nodes are faced with a combination of internal and external commands associated with execution delays. In many cases, a sequence of actions associated with a node may be synchronized in an initial order that is impractical due to uncontrollable delays in the execution of one or more tasks outside of a server's control or even knowledge. For example, a computing node may be involved in a series of concurrently executed network actions that are expected to be completed at different times. The computing node may have an associated runbook that controls the sequence of scheduled actions the node is scheduled to perform in part or in full, and the order of these scheduled actions may result in one or more resource-related criteria being triggered. In the absence of further operations, these nodes or a related node management subsystem may prevent an action or prematurely terminate an initiated action in response to a determination that one or more such criteria have become triggered.

Some embodiments may account for application-ending problems by detecting the likelihood of a resource-related criterion being triggered and, in response, modifying a runbook or other actions sequence associated with the node. After obtaining data indicating that an action for the node has been added to an action sequence for the node, some embodiments may determine a result indicating whether the action will cause a resource allocation level (e.g., an available number of CPU cores) of the node to fail to satisfy a minimum threshold. In response to the result of this determination indicating that a resource allocation may fall below the minimum threshold, a server or other resource management system may (1) delay the execution of one or more actions indicated by the execution sequence, (2) allocate additional resources from a resource pool to the node, and (3) update the action sequence of the resource pool such that these additional resources are confirmed to be available to the node before the execution of one or more delayed actions.

By delaying resource-consuming operations, modifying mode action sequences, or otherwise preventing a set of resource-related criteria from being triggered, some embodiments may benefit the operations of distributed computing operations. Such benefits include reducing the risk that a node generates an error alert or prematurely terminates node operations. Furthermore, such operations can increase the reliability of distributed computing operations for multi-node computing applications, reduce the likelihood of flooding a service log with duplicative warnings, and increase the effective use of a shared resource pool.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an illustrative diagram for reallocating resources to a node, in accordance with one or more embodiments.

FIG. 2 shows a conceptual diagram of an operation to reallocate resources by modifying an action sequence of a node, in accordance with one or more embodiments.

FIG. 3 shows a flowchart of a process for reallocating resources by delaying and rescheduling operations, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

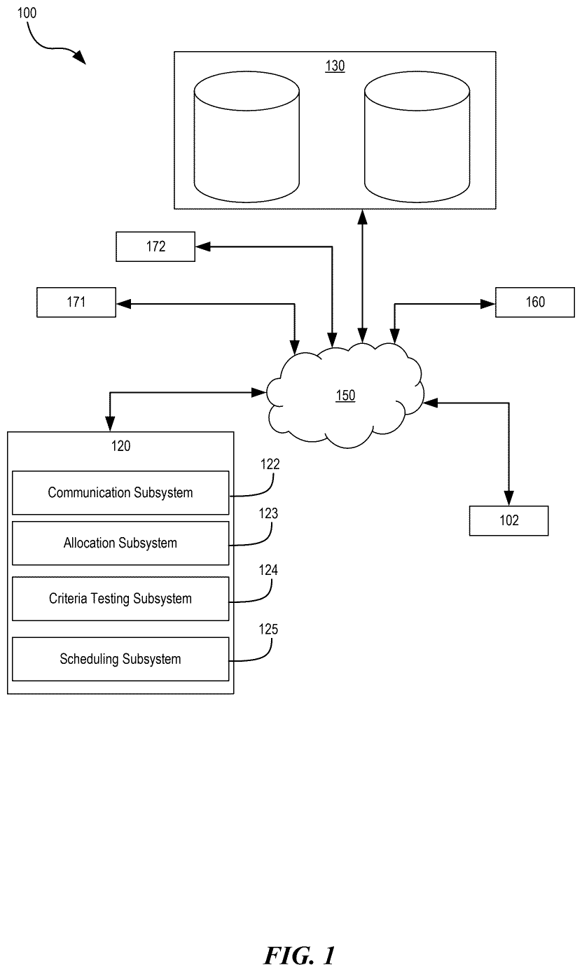

FIG. 1 shows an illustrative diagram for reallocating resources to a node. A system 100 includes a client device 102 in communication with a server 120 via a network 150. The server 120 may also communicate with a first resource-sharing node 171 and a second resource-sharing node 172, which may be orchestrated by, controlled by, or otherwise managed by the server 120. As will be described further in this disclosure, the server 120 may perform operations to determine which decision model to use, synthesize new data from an erroneous sequence for learning model training, or modify the cadence of scheduled training operations.

In some embodiments, in connection with obtaining a result indicating whether an action will cause a resource allocation level of a node to fail to satisfy a threshold (e.g., a prediction that the action will cause the resource allocation level to fall below the threshold), the system 100 may delay the action by a buffer duration and allocate a set of resources from a resource pool to the node. As such, in some embodiments, the set of resources may be available to the node before an end of the buffer duration. At the end of the buffer duration or after the buffer duration, the system 100 may execute the action (or one or more other actions). In this way, for example, because the set of resources are allocated to the node before the end of the buffer duration, the execution of the action may avoid the scenario where the resource allocation level of the node falls below the threshold (e.g., resulting in a node failure or other undesirable outcome related to the node).

For example, in some embodiments, in connection with obtaining an indication that a resource-consuming network operation for the node has been added to a network operation sequence controlling resource-consuming network operations for the node, the system 100 may determine whether the resource-consuming network operation will cause a resource allocation level of the node to fall below a minimum performance threshold. As an example, falling below the minimum performance threshold may indicate a node failure or other undesirable outcome related to the node. In response to a determination that the resource allocation level will fall below the minimum performance threshold, the system 100 may delay the resource-consuming network operation by a buffer duration, where the buffer duration permits another resource allocation network operation to complete before the resource-consuming network operation is executed. The system 100 may insert, into the network operation sequence, a second command to allocate additional resources from a shared resource pool to the node. As an example, the system 100 may assign a priority ranking of the second command (e.g., a priority level higher than that of a priority level for a first command corresponding to the resource-consuming network operation) that causes the second command to occur before the resource-consuming network operation. When the buffer duration elapses, the system 100 may execute the resource-consuming network operation. By implementing a buffer duration that prevents the immediate execution of an operation, some embodiments may create time for a subsystem to respond to the possibility of a resource threshold being violated by the operation or of a premature termination of the operation.

Some embodiments may account for application-ending problems by detecting the likelihood of a resource-related criterion being triggered and, in response, modifying a runbook or other actions sequence associated with the node. After obtaining data indicating that an action for the node has been added to an action sequence for the node, some embodiments may determine a result indicating whether the action will cause a resource allocation level (e.g., an available number of CPU cores) of the node to fail to satisfy a minimum threshold. In response to the result of this determination indicating that a resource allocation may fall below the minimum threshold, a server or other resource management system may (1) delay the execution of one or more actions indicated by the execution sequence, (2) allocate additional resources from a resource pool to the node, and (3) update the action sequence of the resource pool such that these additional resources are confirmed to be available to the node before the execution of one or more delayed actions. By updating the action sequence to allocate additional resources to a node before the first operation takes place, some embodiments may reduce the likelihood of a resource threshold being violated by an initial operation at the node.

By delaying resource-consuming operations, modifying mode action sequences, or otherwise preventing a set of resource-related criteria from being triggered, some embodiments may benefit the operations of distributed computing operations. Such benefits include reducing the risk that a node generates an error alert or prematurely terminates node operations. Furthermore, such operations can increase the reliability of distributed computing operations for multi-node computing applications, reduce the likelihood of flooding a service log with duplicative warnings, and increase the effective use of a shared resource pool.

In some embodiments, the system 100 may obtain a first command to allocate a first set of resources to a node from a resource pool. The node may be connected to a node management system, such as an orchestration system. For example, a server system may receive instructions to execute an application and, as a result, execute a command to allocate processor resources, memory resources, and network resources from a shared memory pool to a node in order to execute the application. It should be understood that, in some embodiments, a resource may include non-computing resources, such a resource indicated in a financial account balance field for a user. Some embodiments may then receive an action that updates an action sequence for the node and determine whether the action will cause the node's resource allocation level to fall below a minimum threshold. In some embodiments, if the resource allocation level falls below the minimum threshold, the node or a server system controlling the node may delay the action by a buffer duration. In some embodiments, the node or a server system controlling the node may use the time to re-arrange the action sequence to prevent one or more minimum thresholds from being violated.

In some embodiments, the system 100 may allocate a first set of resources to a node from a resource pool 160 based on a set of instructions (e.g., instructions to initialize a cluster, instructions to execute an application, etc.). The resource pool 160 may include a set of resources allocated from a cloud computing system that the server 120 may then redistribute to the first resource-sharing node 171, the second resource-sharing node 172, or other computing devices. Examples of resources may include a set of central processing unit (CPU) cores, CPU hours, memory resources (e.g., random access memory capacity, in-memory capacity, long-term storage memory), bandwidth capacity, specialized hardware capacity (e.g., graphical processing unit (GPU) resources), etc. In some embodiments, resources may further include other resources that are stored in a record, such as an account record indicating currency, credit, or financial resources available to a user or entity. Furthermore, while the resource pool 160 is shown as being separate from the server 120, other embodiments may include the resource pool in a server performing operations described in this disclosure.

In some embodiments, a server system may receive instructions to execute one or more actions affecting a node or a record representing the node. For example, a server system may host a service or receive data from a service that provides indications that one or more resource-consuming network operations for the node has been added to a network operation sequence. The network operation sequence may control the order of resource-consuming network operations for the node, and may include operations, such as querying a database record, modifying a database record, downloading data from a data source, updating data at a data source, etc. Some embodiments may compute a running total of resources that would be available or likely to be available for a node or record representing the node after each action. For example, some embodiments may determine that a node will have 200 CPU-hours after a first action, −10 CPU-hours after a second scheduled action, and 300 CPU-hours after a third scheduled action. Based on a determination that at least one of these running total values would violate a minimum threshold by being less than a minimum threshold (e.g., 0.1 CPU-hours), some embodiments may then delay one or more operations (e.g., the second operation) for at least a buffer duration and modify the action sequence such that an additional 200 CPU-hours will be confirmed to be allocated before performing the delayed actions. It should be understood that other resources for account records representing nodes or other types of entities may be similarly determined and that delays may be similarly used to determine whether to delay an action. For example, some embodiments may delay a database transaction or a financial transaction between a first user account and a second user account based on a detected failure to satisfy a minimum account balance threshold (e.g., failing a criterion that prediction of an account balance value does not fall below zero).

As described elsewhere, a node or server system related to the node may receive an action to update an action sequence for a node and then detect that a threshold will be violated by a resource amount associated with one or more actions in the action sequence. Based on this violation, some embodiments may delay one or more actions of the action sequence, such as actions determined to cause a decrease in the resource amount. For example, after determining that a sequence of resource-consuming network operations will cause a network resource to drop below a threshold after a second action, some embodiments may delay the resource-consuming network operation by a buffer duration. During this buffer duration, some embodiments may initialize and execute another resource allocation network operation such that the new resource allocation network operation will be complete before the delayed resource-consuming network operation is started. For example, some embodiments may delay a scheduled resource-consuming operation by 5 minutes and modify an action sequence for the node such that an additional resource amount equal to 100 Megabits per second (Mbps) is confirmed as settled for the node before the 5-minute period elapses.

At the conclusion of the buffer duration and after the confirmation of the additional resource allocation network operation, the node or server system may execute the delayed action without violating any criteria involving a node-related threshold. In some embodiments, operations described in this disclosure may prevent node performance failure or reduce the likelihood of a node performance failure. It should be understood that changing the schedule of resource-related updates may occur for other resource allocation operations as well. For example, some embodiments may delay a currency transaction such that an account record balance does not fall below zero as a result of the transaction and then allocate and finalize additional funds to account record balance such that the allocation is finalized before the transaction is completed. Such operations may improve the system 100 by preventing the initiation of mandatory remediation operations, record synchronization operations, or other scripted operations that may otherwise occur as a result of one or more criteria being violated by a resource-consuming operation.

The client device 102 may include one of various types of computing devices, such as a laptop, a tablet, a desktop, a payment kiosk, a payment terminal, a smartphone, etc. The client device 102 may send requests, responses, or other messages to the server 120 that may require communication with other computing devices or other electronic devices. Additionally, the resource-sharing nodes 172-173 may include various types of computing units, such as physically separate servers, virtual nodes hosted on a single physical machine, or nodes on a cloud computing system. Applications, services, or other operations may use data provided by the client device 102, the server 120, or a set of databases 130. The set of databases 130 may include various types of databases, such as SQL databases, no SQL databases, graph databases, etc. In some embodiments, the server 120 may perform one or more operations related to a communication subsystem 122, a resource allocation subsystem 123, a criteria testing subsystem 124, or a scheduling subsystem 125.

In some embodiments, the communication subsystem 122 may obtain program instructions, commands, queries, parameters, values, or other data from the client device 102 that causes an update to a node. For example, the communication subsystem 122 may receive database transaction messages from the client device 102 that causes updates to a record representing operations of the first resource-sharing node 171. Furthermore, operations performed by the server 120 may allow the communication subsystem 122 to send messages to the set of databases 130, the client device 102, the first resource-sharing node 171, the second resource-sharing node 172, or another computing device described in this disclosure. For example, the communication subsystem 122 may send out resource management commands from the server 120 to the resource pool 160.

In some embodiments, the resource allocation subsystem 123 may allocate, reallocate, or resources. In some embodiments, the resource allocation subsystem 123 may allocate resources reflected in a resource amount associated with the first resource-sharing node 171, the second resource-sharing node 172, or another computing device. For example, the resource allocation subsystem 123 may allocate a number of CPU cores to the first resource-sharing node 171. Furthermore, the resource allocation subsystem 123 may allocate resources that are indicated by records stored in the set of databases 130 or other data stores. For example, the resource allocation subsystem 123 may allocate a resource that causes a field to increase in a record of the set of databases 130.

As described elsewhere, some embodiments may allocate additional resources based on a determination that one or more thresholds will be violated by a resource amount. For example, the resource allocation subsystem 123 may obtain, via the communication subsystem 122, a message indicating that a resource-consuming operation (e.g., a network operation to effectuate a database transaction across separated server clusters) has been initiated. As described elsewhere in this disclosure, the scheduling subsystem 125 may update a sequence controlling the order of resource-consuming network operations and other operations related to the first resource-sharing node 171. In some embodiments, the resource allocation subsystem 123 may then allocate an additional set of resources to the first resource-sharing node 171, where such allocations may be prioritized to occur before the resource-consuming network operation occurs.

In some embodiments, the criteria testing subsystem 124 may determine whether data associated with a node satisfies a set of criteria. The criteria testing subsystem 124 may determine whether a resource amount (e.g., a total number of computing resources for a node) satisfies a corresponding set of criteria (e.g., is greater than a first minimum threshold, is greater than or equal to a second minimum threshold, etc.). For example, the criteria testing subsystem 124 may determine whether a total amount of available processor cores is greater than a processor core threshold. As described elsewhere, violating one or more criteria tested by the criteria testing subsystem 124 may cause the server 120 or a node to stop performing one or more actions scheduled to be performed by the server 120 or the node. For example, the criteria testing subsystem 124 may apply a criterion that a resource amount indicating a total amount of available memory satisfies a minimum performance threshold. If a determination is made that the total amount of available memory does not satisfy the minimum performance threshold, the server 120 or the first resource-sharing node 171 may stop one or more operations that causes the total amount of available memory to violate the minimum performance threshold.

In some embodiments, the scheduling subsystem 125 may schedule a sequence of operations to be performed by a node or otherwise affecting a node. For example, the server 120 may receive instructions to effectuate a set of operations to be performed by the first resource-sharing node 171. The scheduling subsystem 125 may then add the set of operations to an action sequence for the first resource-sharing node 171. Furthermore, the scheduling subsystem 125 may also update action sequences of for records, such as records of the set of databases 130. For example, the scheduling subsystem 125 may update an action sequence of database transactions affecting a record of the set of databases 130.

In some embodiments, the scheduling subsystem 125 may modify a sequence of actions for a node or record. For example, the server 120 may use the criteria testing subsystem 124 to predict whether, after each respective action of a sequence of actions for the first resource-sharing node 171, a resource amount associated with the respective action indicates that the respective action would satisfy a minimum threshold. If the criteria testing subsystem 124 determines that the minimum threshold is violated for a particular action, the scheduling subsystem 125 may delay the action by a buffer duration. For example, the server 120 may then use the resource allocation subsystem 123 to allocate an additional set of resources to the first resource-sharing node 171 assigned to perform the action. Furthermore, the server 120 may use the criteria testing subsystem 124 to modify the action schedule to confirm allocation of the additional set of resources to the first resource-sharing node 171. After this confirmation, the first resource-sharing node 171 may then proceed to execute the previously delayed action at the conclusion of the buffer duration.

As another example, the system 100 may receive a message indicating a transaction request related to reallocating resources away from a record. In response, the system 100 may generate or update an action sequence for that record to initiate the reallocation process. Instead of immediately executing the reallocation operation, the system 100 may delay the reallocation operation to first preallocate an additional amount of resources to the record. For example, the system 100 may modify the action sequence for the record to insert the preallocation operation such that the preallocation will occur before the reallocation. Such operations can avoid triggering a transaction-terminating threshold because the preallocation operation will prevent the total amount of resources allocated to the record from falling below a threshold amount. Once a confirmation is made that the reallocation has occurred, the system 100 may then perform a second reallocation to execute the preallocation amount.

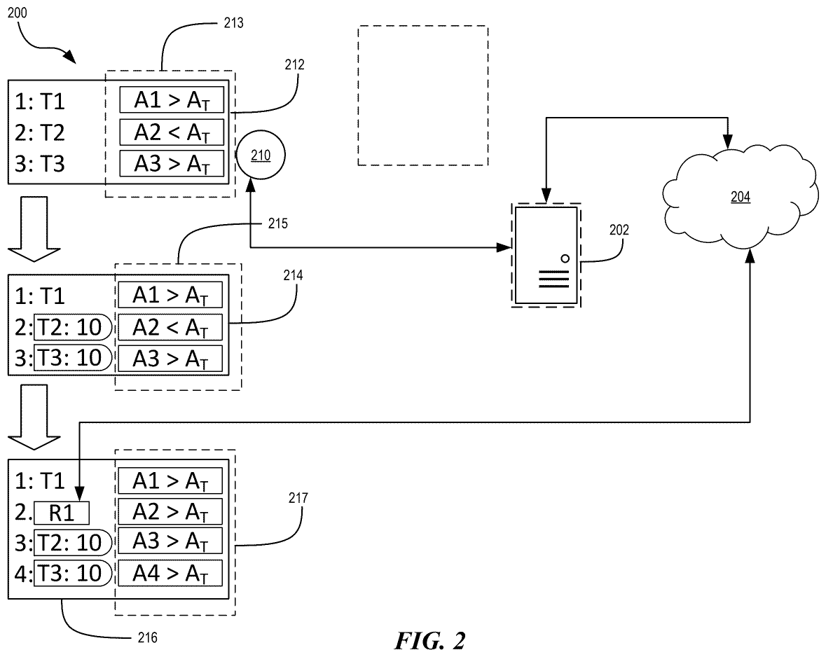

FIG. 2 shows an illustrative diagram of an event sequence to accommodate error drift, in accordance with one or more embodiments. In some embodiments, the system 200 depicts a server system 202. In some embodiments, the server system 202 may or may not include a physical server (e.g., an on-premises server). Alternatively, or additionally, the server system 202 may or may not include a cloud server (e.g., as a virtual machine, as a cloud instance, as a cluster). The server system 202 may include or control a node 210, where the operations related to the node are listed in an action sequence 212. As described elsewhere in this disclosure, some embodiments may modify the action sequence 212 to form a second action sequence 214 and a third action sequence 216.

In some embodiments, the server system 202 or the node 210 may compute or predict an available resource amount “A” before, during, or after each action of a set of actions performed by or otherwise related to the node 210. The set of actions may include various types of operations related to the node 210, such as database transactions effectuated by the node 210, network application operations performed by the node 210, other computing operations. For example, as shown in column 213, the server system 202 may determine that the available resource amount A1 is greater than a minimum threshold A_{T} after action “T1” is performed. The server system 202 may further determine that the available resource amount A2 is less than the minimum threshold A_{T} after action “T2” is performed. The server system 202 may further determine that the available resource amount A3 is greater than the minimum threshold A_{T} after action “T3” is performed.

In some embodiments, based on a determination that the available resource amount A is less than the minimum threshold A_{T} after action “T2” is performed, the server system 202 may delay the actions “T2” and “T3,” as shown in the second action sequence 214. For example, as shown in the second action sequence 214, the server system 202 may delay the actions “T2” and “T3” by 5 minutes. As described elsewhere, some embodiments may delay these operations for a buffer duration to allow the server system 202 or another computing system to allocate additional resources to the node 210. As shown in column 215, the delay may not necessarily change any threshold violations by itself, as the resource amount “A2” remains delayed even after the actions “T2” and “T3” are delayed.

In some embodiments, the server system 202 may modify the action sequence for the node 210 by allocating additional resources from a shared resource pool 204 to the node 210. Furthermore, the server system 202 may modify the second action sequence 214 to provide the additional resources before the actions “T2” and “T3” are performed. For example, as shown in a third action sequence 216, the server system 202 may allocate additional computing resources from the shared resource pool 204 to the 210 in an action “R1.” In some embodiments, the node 210 or the server system 202 may insert the action to allocate resources into the third action sequence 216.

As a part of the allocation process or after it, some embodiments may reorder sequence of actions, such as sequence of network operations affecting a node or a record representing a node. In some embodiments, reordering operations includes one or more operations to prevent a resource-consuming operation from consuming so many resources as to violate a minimum amount threshold (e.g., by being less than the minimum amount threshold). By inserting the operation to allocate additional resources before a resource-consuming operation, a server system, node, or other computing device may change the priority ranking of the actions listed in the third action sequence 216. This priority change may prevent in-flight and settled resource amounts from violating thresholds. Furthermore, by inserting the action “R1” before action “T2,” the server system 202 or node 210 may permit operations to the server system 202 and node 210 to correct for the possibility of a threshold being violated. In some embodiments, the server system 202 may confirm that the new amount of allocated resources has been settled or otherwise confirm its completion of the allocation operation. As shown in column 217, the amounts of resources for the node 210 after the completion of each respective action of the third action sequence 216 indicates that the total available resource amounts are greater than the threshold.

### Flowchart

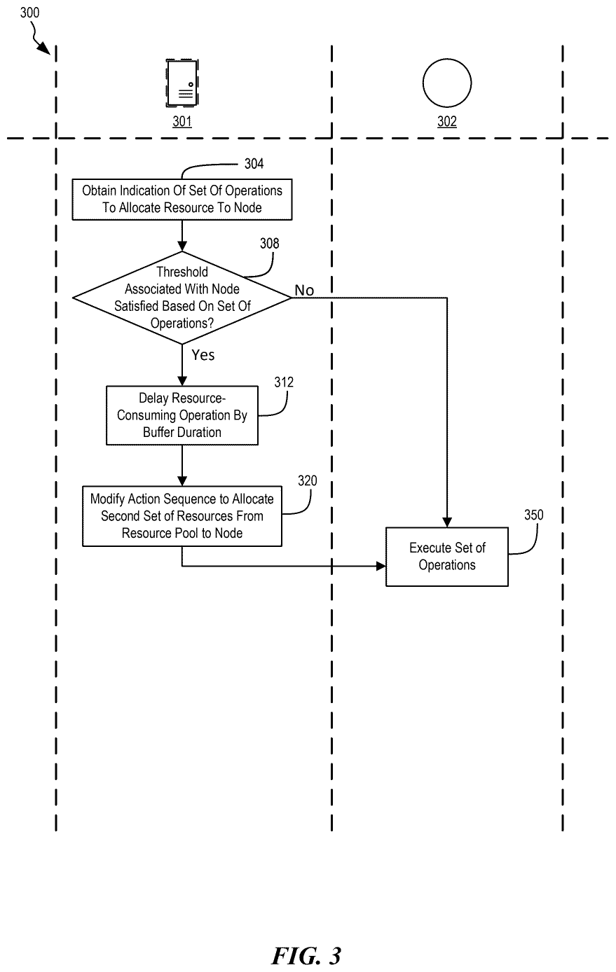

FIG. 3 shows a flowchart of a process 300 for reallocating resources by delaying and rescheduling operations, in accordance with one or more embodiments. Some embodiments may receive an indication of an operation to allocate a resource to a node, as indicated by block 304. In some embodiments, as indicated by column 301, operations described for block 304 may be performed by a server system, such as a server system controlling node operations. In some embodiments, a resource may include various types of resources usable to perform operations, such as a memory resource or a processor resource. For example, some embodiments may allocate or deallocate storage memory to an application using operations described in this disclosure. In some embodiments a processor resource may include time or utilization metrics, such as an amount of time that one or more processors can be used (e.g., CPU time, GPU time, etc.) Alternatively, or additionally, a resource may be represented by values in a record. Furthermore, in some embodiments, a resource may include metrics related to industry-specific fields, such as credit or an amount of cash deposited in an account.

Some embodiments may use in-flight values as indications of operations or actions that affect a node. For example, various types of database transactions may be delayed based on programmatic triggers and verification operations. Such a database transaction may be in-flight in the sense that they will be executed after such verification operations are completed. In many cases, differences between verification operations may cause differences in the total amount of time that different database transactions are in-flight. For example, some embodiments may obtain a set of in-flight values indicating future changes to a node with respect to a resource amount allocated to the note or a resource amount that node operations are scheduled to consume. Some embodiments may determine a predicted future resource amount by taking a sum of resource amounts indicated by the in-flight values. For example, as described elsewhere in this disclosure, some embodiments may determine whether a threshold, such as a minimum performance threshold indicating a minimum performance requirement will be violated. In some embodiments, a server system or node may determine whether a minimum performance threshold is violated based on a sum of in-flight operations scheduled to be executed in an action sequence over a 5-minute duration. Furthermore, minimum performance requirements may include various types of performance minimums, such as a minimum amount of memory, a minimum amount of processor cores, a minimum number of hardware acceleration units, etc.

Some embodiments may determine whether a threshold associated with the node will be satisfied based on the set of operations, as indicated by block 308. In some embodiments, as indicated by the column 301, operations described for block 308 may be performed by a server system. In some embodiments, a set of operations to allocate resources may be deterministic such that a total amount of available resources may be determined before the conclusion of each action related to the set of allocation operations. For example, a first set of operations for a node initially set at 100 CPU-hours may include a first operation to re-allocate a 10 CPU-hours from a node and a second operation to allocate a 100 CPU-hours to the node. Some embodiments may determine a running sum of available resource amounts for the in-flight allocation operations and determine that the node has 90 CPU-hours after completion of the first operation and 190 CPU-hours after completion of the second operation.

In some embodiments, an operation may correspond with a resource consumption or resource addition that is not known before the operation begins. For example, an action sequence may include an operation to use a node's available CPU-hours to execute an application operation, where the total amount of CPU-hours consumed by the operations would be unknown until the operations are completed. In some embodiments, a predetermined estimate may be used to predict an amount of resources consumed for operations with no defined resource consumption amount. For example, an application may be limited to consume a particular amount of resources and use that limit as the predicted amount to be consumed when determining a total allocation amount during or after completion of an action to execute the application. Alternatively, some embodiments may use a prediction model to predict a total amount of resources to be consumed by an application. For example, a server system may train a neural network model or another type of machine learning model to predict an amount of bandwidth that a resource may use based on past network operations and their corresponding past bandwidth utilization values. The server system may provide the trained model with an identifier of the application and a set of input parameters for the application and, in response, obtain a predicted resource consumption amount. For example, the server system may provide the trained model with an application identifier “Splat-Test-Simulation” and application input parameters that include a number “54” and a category identifier “chromium,” where the trained model may then output “12.1” to indicate that 12.1 CPU-hours are predicted to be consumed. Furthermore, some embodiments may predict a range of resource amounts that may be consumed by an operation and use a maximum or minimum of the range. Furthermore, it should be understood that a trained prediction model may also provide a predicted resource amount or a range of predicted resource amounts for operations that add an amount of resources to a node.

In some embodiments, the threshold being satisfied is a minimum threshold, such as a minimum performance threshold that is to be satisfied by a resource amount. For example, some embodiments may determine that a minimum score threshold is satisfied by a set of allocation operations based on a determination that a sum of known or predicted available resource amounts is greater than or equal to the minimum score threshold. For example, if a minimum threshold is zero units, a server application or management system may determine that a minimum threshold is violated by an action sequence if, at any point in the performance or predicted performance of an action, a total resource amount falls below zero units. In some embodiments, the use of “zero” as a threshold criteria may be useful because resource-consuming operations that are found to cause a node to reach zero resources are most likely to fail.

It should be understood that, in some embodiments, the threshold may represent a credit threshold or monetary threshold, and that a resource amount may present a predicted cash amount, where an operation tested against a threshold includes an operation to execute a financial transfer. In some embodiments, a server, node, or other application may determine that a total available financial score determined from scores of completed operations or scores of in-flight operations less than a minimum threshold, In response, some embodiments perform operations similar to or the same as those described for block 350.

Some embodiments may execute program instructions structured to (1) determine whether one or more thresholds are violated and, in response, (2) effectuate one or more self-correcting operations to prevent such violations by causing one or more additional resource allocations. For example, if an operation is actively on an action queue (e.g., by being in flight) some embodiments may execute a method that may allocate an additional amount of resources to a node or a record value of a record. Furthermore, if an operation (e.g., a database transaction, a network operation, an application-specific operation, etc.) has been resolved and no longer in flight, then a server system, node, or other computing device may perform operations to de-allocate a previously allocated amount of resources. Additionally, if a settled, not-in-flight operation is not an explicitly defined allocation of additional resources, some embodiments may still perform operations to determine whether to allocate additional resources.

In response to a determination that the threshold is satisfied based on the allocation operation, some embodiments may proceed to operations described for block 350. Otherwise, operations of the process 300 may proceed to operations described for block 312.

Some embodiments may proceed to perform the initial operation without further resource allocation operations, as indicated by block 312. For example, some embodiments may receive an initial indication (e.g., initial program instructions, an initial set of parameters, etc.) to perform an operation that causes a node to perform an initial action which then causes the node to consume resources of the node. After receiving the instructions or other initial indication, some embodiments may add the resource-consuming action to an action sequence to effectuate corresponding operations associated with the node. Some embodiments may then determine that the resource-consuming action may cause the resource allocation level for the node to increase or otherwise remain greater than the minimum threshold associated with that note. For example, a server system may predict a performance metric indicating an amount of processor resources the initial operation may consume. The server system may then determine that a set of minimum performance thresholds are satisfied based on this predicted performance requirement and, in response, execute the resource-consuming action without modifying the action sequence for the node or otherwise performing operations described for block 312.

Some embodiments may delay the resource consuming operation by a buffer duration, as indicated by block 312. In some embodiments, as indicated by the column 301, operations described for block 312 may be performed by a server system. Some embodiments may use a predefined buffer duration to determine how long to delay an operation. For example, some embodiments may delay one or more operations by 1 minute, 5 minutes, 10 minutes, 20 minutes, or some other time interval. Alternatively, or additionally, some embodiments may dynamically determine the buffer duration based on factors related to how quickly a new allocation transaction may be confirmed. For example, if a resource pool is operating during regular network traffic such that no significant delays to resource allocation operations are expected, a server may delay a set of transaction operations by 5 minutes or another time that is less than or equal to 5 minutes. Furthermore, it should be understood that other delay durations are possible, such as 30 minutes or another period less than 1 hour, another period less than 12 hours, another period less than 24 hours, another period less than 72 hours, or some other period of time. However, if the resource pool is operating under heavy network traffic such that there may be significant delays expected during resource allocation operations, the server may delay the set of transaction operations by 30 minutes (or some other value greater than 5 minutes). Such operations may benefit a system performing the process 300 by creating enough buffer time for the system to perform other operations that may prevent the violation of a set of operation-ending criteria.

Some embodiments may predict the likelihood of a failure event, where such a failure event is related to the likelihood of a minimum threshold or other set of criteria not being satisfied. For example, after each time that a resource-consuming action results in a resource amount falling below a minimum threshold, some embodiments may store a record of this resource-consuming action in a data set of actions (e.g., a data set of actions related to the node). Some embodiments may then update a data set for use as training data. For example, a server system may update a machine learning model that is trained to predict the likelihood of node failure or otherwise predict the likelihood of a set of criteria being violated. In some embodiments, a server system, node, or other computing system may store previous actions in a dataset of actions to use as part of training data. The dataset of actions may include records that indicate various types of network operations, application operations, database transactions, or other actions and associate these actions with downstream effects, such as failure indicators, success indicators, etc.

After training the machine learning model, some embodiments may use this trained machine learning model to more accurately predict whether a threshold is likely to be violated based on a sequence of actions of a node or other data associated with the node. For example, some embodiments may obtain a new sequence of actions indicating a node and provide values of this new sequence of actions to the machine learning model as an input. The machine learning model may then output a result indicating that a predicted failure event will occur, where such a failure event may include a minimum threshold being violated, a node hardware failure, a fraudulent user event, etc. Based on this result, some embodiments may then perform a downstream action that allocates additional resources to the node or to an application that the node is responsible for executing. For example, some embodiments may provide values of a new sequence of actions for a node to a machine learning model and receive an output from the machine learning model indicating that a resource amount stored in association with the node will fall below a threshold. The server system may then allocate additional resources from a shared resource pool to this node in response to determining this output.

Some embodiments may include data about infrastructure failures to the machine learning model, where such data may help improve the machine learning model's generation of outputs that cause a server system to reallocate resources. For example, some embodiments may obtain failure indicators which indicate that components of a cloud network have failed. Failure indicators may indicate various types of device failures, hardware failures, or network infrastructure failures. For example, an indicator of the network infrastructure failure may include indicators that a set of servers have gone off-line, an indicator that a set of computing devices are no longer communicating, an indicator that a set of database records have become flagged as inaccurate, an indicator of other types of failures related to a part of a network, etc. Some embodiments may provide these failure indicators or data associated with these failure indicators to a trained machine learning model to predict whether such failures are associated with an additional delay in resource allocation or with a resource-consuming action that has not been completed. In some embodiments, this trained machine learning model may indicate that a previous resource allocation or other operation that would increase a resource amount associated with the node will fail or be delayed. In response, a server may retrieve or otherwise allocate resources from another resource pool to be used by the node or replace the node with an alternative node. It should also be understood that some embodiments may use a user record to represent the node (e.g. a user account) and may increase a resource amount for the node by increasing a value stored in the record. For example, a server may provide action sequence data or an indication of failure to a machine learning model in order to obtain a machine learning model output indicating that a set of database transactions may be delayed due to hardware failures. In response, the server may change a sequence of operations for a node, where the change may first increase one or more values stored in a user record before one or more thresholds is violated.

Some embodiments may perform one or more additional detection or testing operations before the end of the buffer duration. For example, if a sequence of actions for a node is delayed by 10 minutes, some embodiments may perform a second set of criteria testing operations at the 9-minute mark to determine whether a minimum threshold (e.g., a minimum performance threshold) is satisfied. If this minimum threshold is not satisfied, some embodiments may then extend this buffer duration. For example, some embodiments may extend the 10-minute buffer duration by an additional 5 minutes based on a determination that, at the end of the first 10-minute buffer duration, an expected incoming resource has not been received or incoming resource allocation has not actually been executed. In response, some embodiments may continue to extend the buffer duration to prevent one or more minimum threshold from being violated. Some embodiments may perform such a test to prevent the unnecessary allocation of one or more resources to the node.

Some embodiments may modify the action sequence to allocate a second set of resources from the resource pool to the node, as indicated by block 320. In some embodiments, as indicated by the column 301, operations described for block 320 may be performed by a server system. As described elsewhere in this disclosure, a sequence of actions for a node may represent a set of instructions that will affect data related to a node. For example, one or more actions of the sequence of actions for a node may affect the operations of the node, resources allocated to the node or consumed by the node, or otherwise affect values of a record storing data related to the node. This set of resources being allocated to a node may act as a form of an advance of resources, where such an advance of resources may prevent application failures stemming from automatic application failures caused by the triggering of one or more insufficient resource flags.

In some embodiments, the second set of resources allocated to the node from the resource pool may be a predetermined set of resources. For example, some embodiments may be configured to automatically distribute 10 additional CPU hours to a node without requiring a determination that the additional CPU hours are too much. As an additional example, if a resource represents a monetary amount, some embodiments may transfer $100 into the record associated with the node. Some embodiments may use this predetermined amount to reduce the computing and memory overhead required to advance resources to a node. Alternatively, some embodiments may dynamically determine the amount of resources to assign to a node. For example, some embodiments may determine that an additional 5.5 GB is necessary for an application to be executed to completion by a node and, in response, allocate the additional 5.5 GB to the node. Operations to compute or predict a specific amount of resources to a node based on the node's current resources and one or more action sequences associated with that node may be helpful to preserve the total amount of available resources to distribute from a resource pool.

In cases where a server may determine a resource amount to be allocated to a node instead of using a predetermined amount, some embodiments may determine such an amount based on a minimum threshold. For example, if a minimum amount of computing resources is set at 10 CPU hours, and if a server determines that it should be using operations described by the process 300, the server may allocate an additional 10 CPU hours to the node. It should be understood that other embodiments may determine what resources to allocate and what amount to allocate using other methods. For example, a server may allocate a resource amount equal to the minimum threshold, a resource amount that is a multiple of the minimum threshold, or another resource amount that is computed based on the minimum threshold.

Furthermore, some embodiments may allocate a resource amount equal to an initial value and reduce the actual amount to be allocated from the initial value to a lower value based on a determination that the resource amount allocated to a node is above a minimum available amount threshold. For example, a server system may be configured to allocate an amount of 20 GB of in-memory resources to a node. However, the server may first determine that the available amount of in-memory resources is equal to 5 GB, and that this available amount is greater than a minimum available amount threshold. Some embodiments may also alter a preconfigured amount to be allocated from a resource pool based on an available amount of resources for the resource pool itself. For example, a server system may determine that an available amount of monetary resources in a resource pool is less than a minimum resource pool amount threshold (e.g., $200,000, $300,000, $1,000,000, or another monetary value). In response, the server system may reduce a preconfigured allocation amount that is allocated to a node or a record by default. For example, if a preconfigured amount is measured in CPU-hours, some embodiments may reduce the preconfigured amount from 100 CPU-hours to 10 CPU-hours. In some embodiments, if the resource level rises above the minimum threshold at a later time, some embodiments may then increase the preconfigured amount.

In some embodiments, an actual resource allocation level of a node may never fall below a minimum threshold. For example, after detecting that a user has executed an operation that will cause a resource amount to fall below a memory threshold or network threshold, a server may measure the actual resource utilization of a node during the buffer duration. The node may detect that, for the entirety of the buffer duration, the actual amount of available memory and bandwidth for a node will always exceed a set of minimum thresholds. Some embodiments may measure whether the set of minimum thresholds are violated to determine whether to change a default buffer duration value.

Some embodiments may receive a set of indications that a threshold is not being satisfied by a resource amount allocated to a node. The set of indications may include network device signals, messages sent via hardware APIs, and other types of indications. In response to receiving this set of indications, some embodiments may increase a buffer duration used to determine how long an action or set of actions is delayed. For example, a server system may determine that a set of additional set of CPU cores have been allocated in an action sequence for a node but that such allocations were not secured before a scheduled application operation involving the node occurred. In some cases, an internal safety or monitoring subsystem of the application may test whether a threshold for a resource allocation level is satisfied (e.g., whether a minimum available CPU core threshold is satisfied, whether a total compute time threshold is satisfied, etc.). In some embodiments, the application or another application or service executing on the node or server system may prematurely terminate application operations or prevent an expected performance of the application if this threshold is not satisfied. After detecting the occurrence of such a failure, some embodiments may respond by increasing a default buffer duration to prevent additional instances of such threshold violations occurring. In some embodiments, a determination must be made that a threshold count of different nodes must each indicate that corresponding resource threshold is not satisfied. In some cases, a server system or node may test whether a set of thresholds for resource allocation levels of multiple nodes are satisfied by resource amounts of the multiple nodes. If the resource allocation levels do not satisfy the corresponding set of thresholds, some embodiments may increase a default buffer duration.

Some embodiments may define a function that determines whether one or more thresholds is satisfied and, based on a determination that at least one threshold was violated, trigger a resource advance. For example, some embodiments may define a method that counts the total resource amount “avail_amt_in_flight_or_conf” as a sum of a first value “netpy_res” indicating a confirmed amount stored in a record (e.g., a node-representing record), a second value “netpy_res_in_flight” indicating an amount that a resource is in flight, and a third value “amt_to_source” indicating an amount of the resource. The method may further define a resource amount “pool_in_flight_and_conf” to be allocated in advance and then de-allocated that includes both confirmed advanced amounts and resource amounts that are in-flight (e.g., resource amounts allocated by the server but not yet available for use). In some embodiments, the method may further determine whether the value “avail_amt_in_flight_or_conf” is greater than or equal to a first minimum threshold (e.g., zero) and, if so, advance some amount. For example, if the value “pool_in_flight_and_conf” is not equal to or less than the minimum threshold (which may also be zero). If so, the method may include program code to allocate resources (e.g., by using a command “emit_advance_request”) from a resource pool after accounting for the amount “pool_in_flight_and_conf.” As used in this disclosure, a command to allocate resources may be described as an allocation command.

Some embodiments may execute a set of operations in accordance with the action sequence, as indicated by block 350. In some embodiments, as indicated by the column 302, operations described for block 350 may be performed by a node. As described elsewhere, some embodiments may determine that no thresholds or other criteria are violated and, in response, execute a set of resource-adding or resource-consuming operations. For example, some embodiments may obtain an initial indication that an initial resource-consuming action has been added to an action sequence. Some embodiments may then determine that, for each action of the updated action sequence including the initial resource-consuming action, a corresponding total available resource amount still satisfies a minimum threshold. In response to this initial result, some embodiments may execute the initial resource-consuming action at a scheduled time without inserting any additional network commands or other commands into the action sequence. In some embodiments, a network command may include a command to distribute computing or network resources involving one or more nodes of a network (e.g., an allocation command).

As described elsewhere, some embodiments may determine that one or more thresholds are violated and, in response, execute a set of operations after modifying the action sequence controlling that set of operations. For example, a server system may first re-allocate resources to a node based on a determination that one or more minimum thresholds is satisfied. In some embodiments, after a server system inserts an additional network command to allocate an additional set of resources to the node, the node may then execute the resource-consuming action once the buffer duration elapses.

Some embodiments may return a previously allocated amount once there is no longer a threat of the minimum performance threshold being violated by the initial operation. For example, some embodiments may first modify the action sequence of a node to allocate an additional amount to the node such that the total amount of resources allocated to that node do not fall below a minimum threshold. Some embodiments may then determine the initial action that was indicated to have caused the threshold-violating event was complete and that further actions affecting the node have occurred such that the threshold would no longer be violated. For example, a computing system may determine that a resource-consuming action for a node, such as a set of application operations, has already been performed and that further actions increasing a resource amount allocated to that node have taken place. A node or a server system may then determine that a resource amount associated with that node is sufficiently great such that some or all resources previously allocated to that node as a result of operations for the block 350 may be de-allocated. For example, a server system may initially allocate five hundred processor hours to a node based on operations described in this disclosure. In response, to the server system determining that, after a series of other operations affecting the resource allocation and consumption operations of the node, the total resources allocated to the node will not fall below a minimum threshold, the server system may deallocate the 500 processor hours.

Some embodiments may perform a corresponding increase in a shared resource pool when performing a deallocation. For example, as part of deallocating 500 processor hours from a node, some embodiments may transfer or otherwise reallocate the 500 processor hours to a shared resource pool. This 500 processor hours may then be reallocated to another node using operations described in this disclosure. Furthermore, it should be understood that other resources may be reallocated to a shared resource pool or another node. For example, some embodiments may reallocate memory resources, network resources, financial units, or other resources (e.g., described in this disclosure) to a shared resource pool.

It should be understood that other types of resources may be used, and that such operations may also be applicable in financial operations. For example, some embodiments may credit resources to an account node to avoid the account node from having a resource amount less than zero (or some other threshold value). In some embodiments, a user account record may be treated as a node for the purposes of the descriptions in this disclosure. For example, some embodiments may then determine that a resource amount would not fall below zero even if the additional allocation was removed. In response, some embodiments may transfer the allocated resource amount back to the original resource pool from the user account record.

In some embodiments, the allocation or deallocation of a resource may occur in portions instead of all at once. For example, a server system may receive instructions to deallocate a preset resource amount from a node. The server system may then deallocate a first portion of the resource from the node at a first time point and, at a later time, deallocate a second portion from the node, where the sum of the first and second portions is equal to the total amount to be deallocated. In some embodiments, after each deallocation of a portion, the server system or the node itself may determine that, as a result of further operations, additional deallocation operations may cause the total resource amount to fall below the minimum resource threshold and, based on this determination, prevent further deallocation operations. By allocating or de-allocating amounts in piecemeal portions, some embodiments may decrease the likelihood that a threshold is inadvertently violated. As described elsewhere in this disclosure, the violation of a threshold may cause a series of cascading failures, such as application failure or the inadvertent parasitic transfer of computing resources from other nodes.

It should be understood that any assignment of an operation to a particular component or system is not restricted to that system. For example, while the modification of the action sequence may be performed by a server system as indicated in the process 300, some embodiments may modify the action sequence using a computing node in communication with the server system.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, the client device 102 of FIG. 1 may be a smartphone, another type of mobile computing device, or a payment terminal. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

### ENUMERATED EMBODIMENTS

The present techniques will be better understood with reference to the following enumerated embodiments:
1. A method comprising: determining a result indicating whether an action will cause a resource allocation level of a node to fail to satisfy a threshold; based on the result, delaying the action by a buffer duration and allocating a set of resources from a resource pool to the node, wherein the set of resources is available to the node before an end of the buffer duration; and
executing one or more actions at the end of the buffer duration or after the buffer duration.
2. A method comprising: obtaining a first command to allocate, from a resource pool, a first set of resources to a node; obtaining an indication that an action for the node has been added to an action sequence for the node; determining a result indicating whether the action will cause a resource allocation level of the node to fail to satisfy a threshold; based on the result, delaying the action by a buffer duration; allocating a second set of resources from the resource pool to the node, wherein the second set of resources is available to the node before an end of the buffer duration; and executing the action at the end of the buffer duration or after the buffer duration.
3. A method comprising: executing a first command to allocate, from a shared resource pool, a computing resource to a node associated with a minimum performance threshold indicating a minimum performance requirement for the node; obtaining an indication that a resource-consuming network operation for the node has been added to a network operation sequence controlling resource-consuming network operations for the node; determining whether the resource-consuming network operation will cause a resource allocation level of the node to fall below the minimum performance threshold, wherein falling below the minimum performance threshold indicates a node failure; in response to a determination that the resource allocation level will fall below the minimum performance threshold, delaying the resource-consuming network operation by a buffer duration, wherein the buffer duration permits another resource allocation network operation to complete before the resource-consuming network operation is executed; inserting, into the network operation sequence, a second command to allocate additional resources from the shared resource pool to the node, wherein a priority ranking of the second command causes the second command to occur before the resource-consuming network operation; and executing the resource-consuming network operation when the buffer duration elapses.
4. A method comprising: executing a first network command to allocate, from a shared resource pool on a network, a computing resource to a node associated with a minimum performance threshold; obtaining an indication that a resource-consuming action for the node has been added to an action sequence for the node; determining a result indicating that the resource-consuming action will cause a resource allocation level of the node to fall below the minimum performance threshold; in response to the result, delaying the resource-consuming action by a buffer duration; inserting, into the action sequence, a second command to allocate a second set of resources from the shared resource pool to the node, wherein the second set of resources is available to the node before an end of the buffer duration; and executing the resource-consuming action when the buffer duration elapses.
5. The method of any of the embodiments above, wherein the indication is a first indication, and wherein the resource-consuming action is a first resource-consuming action, and wherein the result is a first result, further comprising: obtaining a second indication that a second resource-consuming action for the node has been added to the action sequence for the node; determining a second result indicating that the resource-consuming action will cause the resource allocation level to fail to satisfy the minimum performance threshold without the second set of resources from the shared resource pool; and in response to the second result, deallocating the second set of resources from the node.
6. The method of any of the embodiments above, wherein deallocating the second set of resources from the node comprises: de-allocating a first portion of the second set of resources during a first block of time after the buffer duration; and de-allocating a second portion of the second set of resources during a second block of time that occurs after the first block of time.
7. The method of any of the embodiments above, wherein the indication is a first indication, and wherein the resource-consuming action is a first resource-consuming action, and wherein the result is a first result, further comprising: obtaining an initial indication that an initial resource-consuming action for the node has been added to the action sequence; determining an initial result that the resource-consuming action increases will cause the resource allocation level of the node to be greater than the minimum performance threshold; and in response to the initial result, executing the resource-consuming action without inserting an additional command into the action sequence.
8. The method of any of the embodiments above, wherein the indication is a first indication, and wherein the resource-consuming action is a first resource-consuming action, and wherein the result is a first result, further comprising: storing a record of the resource-consuming action in a dataset of actions related to the node; updating a machine learning model to predict a node failure based on the dataset of actions; obtaining a new sequence of actions indicating the node; and providing values of the new sequence of actions to the machine learning model to obtain a second result indicating that a predicted failure event will occur; and allocating a third set of resources from the shared resource pool to the node based on the second result.
9. The method of any of the embodiments above, further comprising obtaining a failure indicator that indicates that a network infrastructure failure, wherein providing the values to the machine learning model comprises providing the failure indicator to the machine learning model.
10. The method of any of the embodiments above, further comprising: detecting, before an end of the buffer duration, a second result indicating that the minimum performance threshold is not satisfied; and in response to a determination that the buffer duration is not satisfied, extending the buffer duration.
11. The method of any of the embodiments above, wherein the computing resource comprises at least one of a memory resource or a processor resource.
12. The method of any of the embodiments above, wherein the buffer duration is less than or equal to 10 minutes.
13. The method of any of the embodiments above, wherein the second set of resources comprises a preconfigured allocation amount.
14. The method of any of the embodiments above, further comprising: determining a second result indicating that the action will cause the resource allocation level to exceed the threshold without the second set of resources from the resource pool; and in response to the second result, de-allocating the second set of resources from the node.
15. The method of any of the embodiments above, wherein allocating the second set of resources comprises: determining a resource amount required to add to the resource allocation level of the node such that a sum of the resource amount and the resource allocation level satisfies the threshold; and determining the second set of resources based on the resource amount.
16. The method of any of the embodiments above, wherein allocating the second set of resources comprises: determining whether a resource amount of the resource pool satisfies a minimum resource pool amount threshold; and reducing a preconfigured allocation amount from an initial value to a lower value based on a determination that the resource amount of the resource pool does not satisfy the minimum resource pool amount threshold, wherein allocating the second set of resources comprises allocating resources based on the preconfigured allocation amount.
17. The method of any of the embodiments above, wherein: obtaining the indication comprises obtaining a set of in-flight values indicating future changes to the node; and determining the result comprises determining whether a sum determined based on the set of in-flight values satisfies the threshold.
18. The method of any of the embodiments above, wherein the threshold is equal to zero.
19. The method of any of the embodiments above, further comprising: receiving a set of indications that the threshold is not satisfied by resource allocation levels of a plurality of nodes; in response to receiving the set of indications, increasing the buffer duration.
20. The method of any of the embodiments above, wherein the resource allocation level satisfies the threshold during the buffer duration.
21. The method of any of the embodiments above, wherein allocating the second set of resources comprises updating a user account record representing the node.
22. A tangible, non-transitory, machine-readable medium storing instructions that, when executed by a data processing apparatus, cause the data processing apparatus to perform operations comprising those of any of embodiments 1-21.
23. A system comprising one or more processors; and memory storing instructions that, when executed by the processors, cause the processors to effectuate operations comprising those of any of embodiments 1-21.
24. A system comprising means for performing any of embodiments 1-21.

What is claimed is:

1. A system for preventing node performance failure of a node by delaying and reordering a sequence of network operations controlling resource allocations to resource-sharing nodes, the system comprising one or more processors and one or more non-transitory, machine-readable media storing program instructions causing the one or more processors to perform operations comprising:
executing a first allocation command to allocate, from a shared resource pool, a computing resource to a node associated with a minimum performance threshold indicating a minimum performance requirement for the node;
obtaining an indication that a resource-consuming network operation for the node has been added to a network operation sequence controlling resource-consuming network operations for the node;
determining whether the resource-consuming network operation will cause a resource allocation level of the node to fall below the minimum performance threshold, wherein falling below the minimum performance threshold indicates a node failure;
in response to a determination that the resource allocation level will fall below the minimum performance threshold, delaying the resource-consuming network operation by a buffer duration, wherein the buffer duration permits another resource allocation network operation to complete before the resource-consuming network operation is executed;
inserting, into the network operation sequence, a second allocation command to allocate additional resources from the shared resource pool to the node, wherein a priority ranking of the second allocation command causes the second allocation command to occur before the resource-consuming network operation; and
executing the resource-consuming network operation when the buffer duration elapses.

2. The system of claim 1, wherein the indication is a first indication, and wherein the resource-consuming network operation is a first resource-consuming network operation, the operations further comprising:
obtaining a second indication that a second resource-consuming action for the node has been added to the network operation sequence for the node;
determining that the first resource-consuming network operation will cause the resource allocation level to satisfy the minimum performance threshold without the additional resources from the shared resource pool; and
in response to determining that the first resource-consuming network operation will cause the resource allocation level to satisfy the minimum performance threshold, deallocating the additional resources from the node.

3. The system of claim 1, wherein the indication is a first indication, and wherein the resource-consuming network operation is a first resource-consuming network operation, the operations further comprising:
storing a record of the first resource-consuming network operation in a dataset of actions related to the node;
updating a machine learning model to predict a node failure based on the dataset of actions;
obtaining a new sequence of actions indicating the node;
providing values of the new sequence of actions to the machine learning model to obtain a second indication that a predicted failure event will occur; and
allocating a third set of resources from the shared resource pool to the node based on the second indication.

4. A method for controlling allocations of resources by reordering a sequence of actions controlling resource allocations to resource-sharing nodes, comprising:
executing a first network command to allocate, from a shared resource pool on a network, a computing resource to a node associated with a minimum performance threshold;
obtaining an indication that a resource-consuming action for the node has been added to an action sequence for the node;
determining a result indicating that the resource-consuming action will cause a resource allocation level of the node to fall below the minimum performance threshold;
in response to the result, delaying the resource-consuming action by a buffer duration;
inserting, into the action sequence, a second network command to allocate a second set of resources from the shared resource pool on the network to the node, wherein the second set of resources is available to the node before an end of the buffer duration; and
executing the resource-consuming action when the buffer duration elapses.

5. The method of claim 4, wherein the indication is a first indication, and wherein the resource-consuming action is a first resource-consuming action, and wherein the result is a first result, further comprising:
obtaining a second indication that a second resource-consuming action for the node has been added to the action sequence for the node;
determining a second result indicating that the resource-consuming action will cause the resource allocation level to satisfy the minimum performance threshold without the second set of resources from the shared resource pool; and
in response to the second result, deallocating the second set of resources from the node.

6. The method of claim 5, wherein deallocating the second set of resources from the node comprises:
de-allocating a first portion of the second set of resources during a first block of time after the buffer duration; and
de-allocating a second portion of the second set of resources during a second block of time that occurs after the first block of time.

7. The method of claim 4, wherein the indication is a first indication, and wherein the resource-consuming action is a first resource-consuming action, and wherein the result is a first result, further comprising:
obtaining an initial indication that an initial resource-consuming action for the node has been added to the action sequence;
determining an initial result that the resource-consuming action increases will cause the resource allocation level of the node to be greater than the minimum performance threshold; and
in response to the initial result, executing the resource-consuming action without inserting an additional command into the action sequence.

8. The method of claim 4, wherein the indication is a first indication, and wherein the resource-consuming action is a first resource-consuming action, and wherein the result is a first result, further comprising:
storing a record of the resource-consuming action in a dataset of actions related to the node;
updating a machine learning model to predict a node failure based on the dataset of actions;
obtaining a new sequence of actions indicating the node;
providing values of the new sequence of actions to the machine learning model to obtain a second result indicating that a predicted failure event will occur; and
allocating a third set of resources from the shared resource pool to the node based on the second result.

9. The method of claim 8, further comprising obtaining a failure indicator that indicates that a network infrastructure failure, wherein providing the values to the machine learning model comprises providing the failure indicator to the machine learning model.

10. The method of claim 4, further comprising:
detecting, before an end of the buffer duration, a second result indicating that the minimum performance threshold is not satisfied; and
in response to a determination that the buffer duration is not satisfied, extending the buffer duration.

11. The method of claim 4, wherein the second set of resources comprises a preconfigured allocation amount.

12. One or more non-transitory, machine-readable media storing program instructions that, when executed by one or more processors, causes operations comprising:
obtaining a first command to allocate, from a resource pool, a first set of resources to a node;
obtaining an indication that an action for the node has been added to an action sequence for the node;
determining a result indicating whether the action will cause a resource allocation level of the node to fail to satisfy a threshold;
based on the result, delaying the action by a buffer duration;
allocating a second set of resources from the resource pool to the node, wherein the second set of resources is available to the node before an end of the buffer duration; and
executing the action at the end of the buffer duration or after the buffer duration.

13. The one or more non-transitory, machine-readable media of claim 12, further comprising:
determining a second result indicating that the action will cause the resource allocation level to exceed the threshold without the second set of resources from the resource pool; and
in response to the second result, de-allocating the second set of resources from the node.

14. The one or more non-transitory, machine-readable media of claim 12, wherein allocating the second set of resources comprises:
determining a resource amount required to add to the resource allocation level of the node such that a sum of the resource amount and the resource allocation level satisfies the threshold; and
determining the second set of resources based on the resource amount.

15. The one or more non-transitory, machine-readable media of claim 12, wherein allocating the second set of resources comprises:
determining whether a resource amount of the resource pool satisfies a minimum resource pool amount threshold; and
reducing a preconfigured allocation amount from an initial value to a lower value based on a determination that the resource amount of the resource pool does not satisfy the minimum resource pool amount threshold, wherein allocating the second set of resources comprises allocating resources based on the preconfigured allocation amount.

16. The one or more non-transitory, machine-readable media of claim 12, wherein:
obtaining the indication comprises obtaining a set of in-flight values indicating future changes to the node; and
determining the result comprises determining whether a sum determined based on the set of in-flight values satisfies the threshold.

17. The one or more non-transitory, machine-readable media of claim 12, wherein the threshold is equal to zero.

18. The one or more non-transitory, machine-readable media of claim 12, further comprising:
receiving a set of indications that the threshold is not satisfied by resource allocation levels of a plurality of nodes; and
in response to receiving the set of indications, increasing the buffer duration.

19. The one or more non-transitory, machine-readable media of claim 12, wherein the resource allocation level satisfies the threshold during the buffer duration.

20. The one or more non-transitory, machine-readable media of claim 12, wherein allocating the second set of resources comprises updating a user account record representing the node.
